(19) United States
(12) Patent Application Publication
(10) Pub. No.: US 2016/0221581 A1
(43) Pub. Date: Aug. 4, 2016

(54) SYSTEM AND METHOD FOR CLASSIFYING A ROAD SURFACE

(71) Applicant: GM Global Technology Operations LLC, Detroit, MI (US)

(72) Inventors: Gaurav Talwar, Novi, MI (US); Xufang Zhao, Windsor (CA); Ron M. Hecht, Raanana (IL); Thomas M. Forest, Macomb, MI (US)

(21) Appl. No.: 14/609,140

(22) Filed: Jan. 29, 2015

(51) Int. Cl. B60W 40/06; G01N 29/44; G01N 29/30; B60W 30/00; G01N 29/04

(52) U.S. Cl. CPC B60W 40/06; B60W 30/00; G01N 29/04; G01N 29/30; G01N 29/4445

(57) ABSTRACT

A method for classifying a road surface being traversed by a vehicle. The method comprises receiving one or more electrical signals each representative of a vibration detected by a sensor carried by the vehicle. The method further comprises identifying, for at least one of the received electrical signals, a pattern in the detected vibration represented by that/those signal(s), and matching the identified pattern to one of one or more known patterns, wherein each known pattern corresponds to a respective road surface classification. The method further comprises classifying the road surface in accordance with the road surface classification corresponding to the known pattern matching the identified pattern. A system comprising one or more sensors carried by the vehicle that is/are configured to detect a vibration, and a pattern classification system for performing the methodology described above, is also provided.

### TECHNICAL FIELD

The present invention generally relates to a vehicle control system, and more particularly, to a vehicle control system and method for classifying a road surface being traversed by a vehicle.

### BACKGROUND

Characteristics of the road surface being traversed by a vehicle may impact the operation of the vehicle in a number of ways. One obvious way is the way in which a driver operates the vehicle, as a vehicle traversing a road surface having certain characteristics may be operated differently than if the road surface had different characteristics. For example, a vehicle traversing an ice covered road surface may be operated at a lower speed than it otherwise would if the road surface was dry and clear.

Another way in which characteristics of a road surface may impact the operation of a vehicle relates to the operation or functionality of certain systems or features of the vehicle. More specifically, the road surface being traversed by a vehicle may cause noise in the passenger cabin of the vehicle, and that noise may be different for different road surface characteristics. For instance, a road surface formed of concrete slabs may cause a continuous noise in the vehicle cabin with intermittent “thumps” as the vehicle passes over transitions between slabs, whereas a road surface formed of asphalt may cause a continuous noise different than that caused by concrete and without intermittent thumps. In any event, this noise may adversely affect the functionality or performance of certain vehicle systems, for example, in-vehicle voice-activated or speech-recognition systems (e.g., hands free calling) that operate on voice commands that may be interfered with by noise in the passenger cabin caused by the road surface.

Yet another way relates to the comfort and/or enjoyment of the occupant(s) of the vehicle. Similar to the above, noise caused in the vehicle cabin by the road surface may prove distracting or unpleasant to vehicle occupant(s).

In view of the foregoing, it may be beneficial for a control system of a vehicle to be able to classify or characterize the road surface being traversed in order to address or account for effects that the road surface has on the operation of the vehicle, including, but not limited to, one or more of those described above.

### SUMMARY

According to one embodiment, there is provided a method for classifying a road surface being traversed by a vehicle. The method comprises receiving at a pattern classification system one or more electrical signals each representative of a vibration detected by a sensor carried by the vehicle. The method further comprises identifying, by the pattern classification system and for at least one of the received signals, a pattern in the detected vibration represented thereby, and matching, by the pattern classification system, the identified pattern to one of one or more known patterns, wherein each known pattern corresponds to a respective road surface classification. The method still further comprises classifying, by the pattern classification system, the road surface in accordance with the road surface classification corresponding to the known pattern matching the identified pattern.

According to another embodiment, there is provided a method for classifying a road surface being traversed by a vehicle. The method comprises receiving at a pattern classification system at least one audio signal representative of a sound detected by a microphone carried by the vehicle, and at least one vibration signal representative of a vibration detected by a vibration sensor carried by the vehicle. The method further comprises identifying, by the pattern classification system and for each of the at least one audio signal and at least one vibration signal, a pattern in the detected sound and detected vibration, respectively, and matching, by the pattern classification system, the identified pattern in the detected sound to a first of a plurality of known patterns, and the identified pattern in the detected vibration to a second of the plurality of known patterns, wherein the first known pattern corresponds to a road surface classification that is in terms of a first characteristic of the road surface, and the second known pattern corresponds to a road surface classification that is in terms of a second characteristic of the road surface. The method still further comprises classifying, by the pattern classification system, the road surface in accordance with the road surface classifications corresponding to the first and second known patterns.

According to yet another embodiment there is provided a vehicle control system for classifying a road surface being traversed by a vehicle. The system comprises one or more sensors carried by the vehicle and each being configured to detect a vibration. The control system further comprises a pattern classification system electrically connected to the one or more sensors and configured to receive one or more electrical signals representative of a detected vibration from the one or more sensors, wherein the pattern classification system is configured to: identify a pattern in the detected vibration represented by at least one of the one or more received electrical signals; match the identified pattern to one of one or more known patterns, wherein each known pattern corresponds to a respective road surface classification; and classify the road surface in accordance with the road surface classification corresponding to the known pattern matching the identified pattern.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic view of an illustrative embodiment of a vehicle having a vehicle control system that is configured to classify a road surface being traversed by the vehicle;

FIG. 2 is a block diagram view of an illustrative embodiment of a vehicle control system of the vehicle illustrated in FIG. 1; and

FIGS. 3 and 4 are flowcharts showing an illustrative embodiment of various steps of a method for classifying a road surface being traversed by a vehicle.

### DETAILED DESCRIPTION OF THE EMBODIMENTS

The vehicle control system and method described herein can be used to classify a road surface being traversed by a vehicle. In an embodiment, the vehicle control system and method may classify a road surface being traversed by receiving one or more electrical signals each representative of a vibration detected by a sensor carried by the vehicle. For at least one of the one or more received signals, a pattern in the detected vibration represented thereby may be identified and matched to one of one or more known patterns, each of which corresponds to a respective road surface classification. The road surface being traversed may then be classified in accordance with the road surface classification corresponding to the known pattern matching the identified pattern. Once the road surface is classified, one or more actions may be taken to, for example, enhance the safety, comfort, and enjoyment of the occupant(s) of the vehicle, and/or the operation of one or more vehicle systems (e.g., in-vehicle voice-based systems).

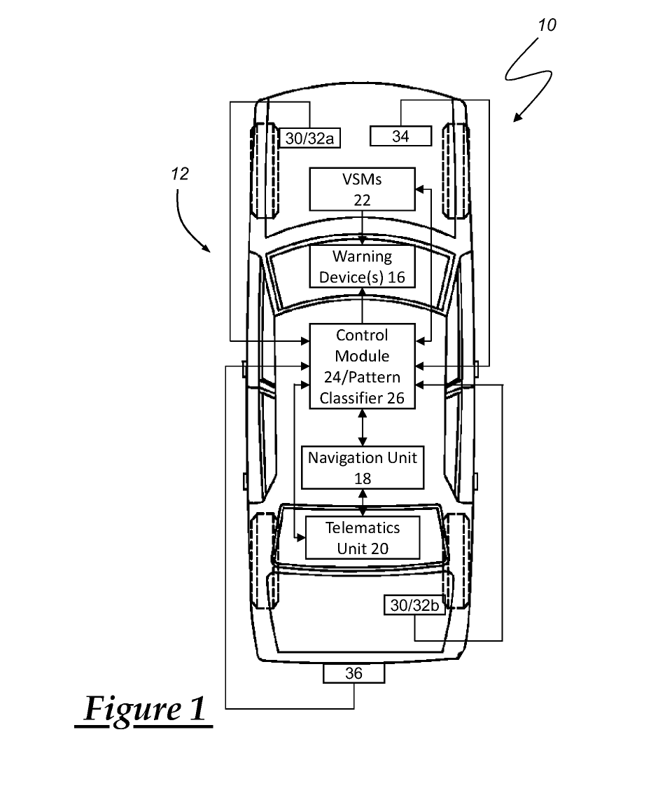

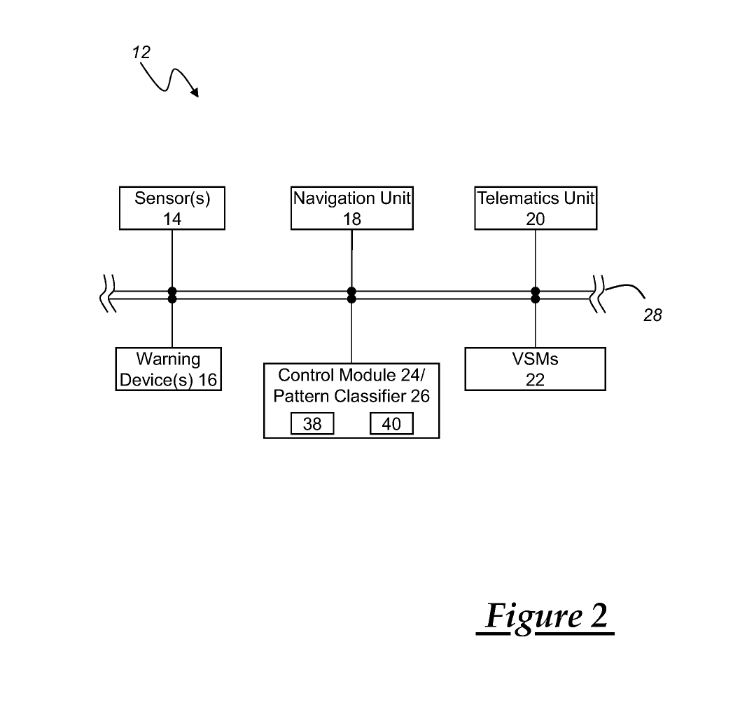

With reference to FIG. 1, there is shown schematic representation of a vehicle 10 equipped with a vehicle control system 12 capable of classifying a road surface being traversed by the vehicle 10. It should be appreciated that the vehicle control system 12 and method described below may be used with any type of vehicle, including traditional passenger vehicles, sports utility vehicles (SUVs), cross-over vehicles, trucks, vans, buses, recreational vehicles (RVs), motorcycles, etc. These are merely some of the possible applications, as the vehicle control system 12 and method described herein are not limited to the illustrative embodiment of vehicle 10 shown in FIG. 1 and could be implemented with any number of different vehicles. As shown in FIG. 1 and FIG. 2, which is a block diagram representation of an illustrative embodiment of the vehicle control system 12, in one embodiment, vehicle control system 12 includes sensor(s) 14, warning device(s) 16, a navigation system or unit 18, a telematics unit 20, one or more vehicle system modules (VSMs) 22, a control module 24, and a pattern classifier or classification system or module 26, which, in the illustrated embodiment, is integrated in the control module 24. It will be appreciated, however, that in other embodiments, vehicle control system 12 may include more or less than those components identified above.

Any number of different sensors, components, devices, modules, systems, etc. may provide the vehicle control system 12 with information, data, and/or other input. These include, for example, the components illustrated in FIGS. 1 and 2, as well as others that are known in the art but not shown here. It should be appreciated that the sensors, control module, VSMs and any other component that is a part of and/or used by the vehicle control system 12 may be embodied in hardware, software, firmware, or some combination thereof. These components may directly sense or measure the conditions or parameters for which they are provided, or they may indirectly evaluate such conditions or parameters based on information provided by other sensors, components, devices, modules, systems, etc. Furthermore, these components may be directly coupled to the control module 24 and/or one or more other components, indirectly coupled via other electronic devices, a vehicle communications bus (e.g., bus 28 shown in FIG. 2), network, etc., or coupled according to some other arrangement known in the art. These components may be integrated within another vehicle component, device, module, system, etc. (e.g., sensors that are already a part of a VSM 22 (e.g., a traction control system (TSC), electronic stability control (ESC) system, antilock brake system (ABS), collision avoidance or active safety system, etc.), and/or the functionality of one component may be integrated into another component (e.g., the functionality of the pattern classifier 26 may be performed or carried out by, for example, any suitable vehicle control module, for example, control module 24 or a VSM 22), may be standalone components, or may be provided according to some other arrangement. In some instances, multiple sensors might be employed to sense or detect a single parameter (e.g., for providing redundancy). It should be appreciated that the foregoing scenarios represent only some of the possibilities, as any type of suitable arrangement or architecture may be used to carry out the method described herein.

The sensor(s) 14 may include any type of sensing or other component carried by the vehicle that provide(s) the present vehicle control system 12 and method with data or information that may be used to, among other things, classify the road surface being traversed by the vehicle 10. In an illustrative embodiment, the sensor(s) 14 include one or more sensors configured to detect or sense a vibration that is indicative of one or more characteristics of the road surface being traversed, and that may be used to classify the road surface being traversed (i.e., different road surfaces or road surface characteristics will have a different, unique vibration signature, and thus, a detected vibration may be used to classify the road surface in terms of one or more characteristics of the road surface (e.g., road surface type and/or road surface condition).

More particularly, in an embodiment, the sensor(s) 14 may comprise one or more microphones 30 each of which is configured to sense or detect a vibration in the form of a sound (sound being a vibration propagating as an audible mechanical wave through air) generated as the vehicle moves. The sound detected or sensed by the microphone(s) 30 may be a sound generated by the interaction of the tires of the vehicle 10 and the road surface as the travel(s) over the road surface, or may be the sound generated as a component of the vehicle, for example and without limitation, a chassis component of the vehicle (e.g., a component of the vehicle frame) vibrates as a result of the vehicle traveling over the road surface being traversed. Depending on the particular implementation, one or more microphones may be used to detect or sense one of these sounds, or different microphones may be employed to sense or detect different sounds.

In the illustrative embodiment depicted in FIG. 1, the vehicle control system 12 includes a plurality of microphones 30 each configured to sense or detect a sound generated as one or more tires of the vehicle 10 travel(s) over the road surface being traversed, and to generate an electrical signal representative of that sound. More specifically, vehicle control system 12 includes pair of microphone clusters 32a, 32b each of which is comprised of one or more, and in an embodiment, a plurality, of microphones 30. The microphones in each cluster may each be arranged and/or oriented in various ways, and in an embodiment, each microphone in a given cluster may have an arrangement/orientation that is different from that of one or more other microphones in that cluster. While the embodiment described herein includes a pair of microphone clusters each comprised of a plurality of microphones, it will be appreciated that in other embodiments, one or both microphone clusters may be comprised of a single microphone, and/or the vehicle control system 12 may include more or less than a pair of microphone clusters. In any event, in the illustrated embodiment, the microphone cluster 32a is carried by the vehicle at or near the forward or front end of the vehicle 10, while microphone cluster 32b is carried by the vehicle at or near the rearward or rear end of the vehicle 10. One reason for arranging the microphone clusters in this manner is to account for distortion that may occur in the output of the microphones of one of the clusters. For example, if the vehicle 10 is traveling into a head wind, the output signals of the microphones 30 of cluster 32a located at the front of the vehicle may be distorted to such a degree that the signals are effectively unusable for the purposes described herein; however, the output signals of the microphones 30 of cluster 32b may be unaffected by the head wind, or at least not affected to such a degree that they are effectively unusable for the purposes described herein. In at least some embodiments, the microphone clusters 32a, 32b are located external to the passenger cabin of the vehicle, and may be respectively mounted in or on the front and rear bumpers of the vehicle 10, within respective wheel wells of vehicle 10, or may be mounted or located in another suitable location. In other embodiments, however, one or both of the clusters may be located inside the passenger cabin. The microphones may be any suitable type of microphone, for example, MEMS microphones, though other types of microphones may certainly be used, such as, for example and without limitation, omnidirectional microphones (e.g., those used in other automotive applications).

The sensor(s) 14 may additionally or alternatively include one or more vibration sensors each of which is configured to detect or sense a vibration in the form of a vibration of a component of the vehicle 10, for example and without limitation, a chassis component of the vehicle (e.g., a component of the vehicle frame) that vibrates as a result of the vehicle traveling over the road surface being traversed. In the illustrative embodiment depicted in FIG. 1, the vehicle control system 12 includes a single vibration sensor 34 configured to sense or detect a vibration and to generate an electrical signal representative of that detected vibration. While the embodiment shown in FIG. 1 includes a single vibration sensor, it will be appreciated that in other embodiments multiple vibration sensors may be used. In at least some embodiments, the vibration sensor 34 is located external to the passenger cabin of the vehicle (e.g., mounted or carried by a chassis component or another suitable component of the vehicle); In other embodiments, however, the vibration sensor 34 may be located inside the passenger cabin. Any suitable vibration sensor known in the art may be used, as the present system and method are not limited to any particular type of vibration sensor.

In at least some embodiments, sensors 14 may include one or more sensors in addition to vibration detecting sensors, some or all of which may be used in conjunction with the vibration detecting sensors or for entirely different purposes. For example, in some embodiments, the sensor(s) 14 include one or more cameras 36. Camera(s) 36 may be configured to capture images of the road surface being traversed and to generate electrical signals representative of the captured images. As will be described below, these signals may then be processed using image processing techniques to determine a classification of the road surface.

In at least some embodiments, the output signals of the camera(s) 36 may be used to supplement the road surface classification that is initially made using output signal(s) of the vibration detecting/sensing sensor(s) described above (i.e., the signal(s) from the camera(s) may be used to further classify the road surface in terms of a different characteristic of the road surface—e.g., in an instance wherein the output(s) of the vibration detecting sensor(s) can be used to classify the road surface in terms road surface type, the output(s) of the camera(s) may be used to classify the road surface in terms of road surface condition, or vice versa). Alternatively, and as will be described in greater detail below, the output signal(s) of the camera(s) 36 may be used as a means to verify or confirm a classification made using the output signal(s) of the vibration detecting sensor(s). In any event, the camera(s) 36 may take a number of forms. For example, in an embodiment such as that shown in FIG. 1, the camera(s) 36 may comprise a camera mounted at the rear of the vehicle (e.g., a backup or parking assist camera carried on or in the rear bumper of the vehicle). In other embodiments, however, the camera(s) 36 may comprise a camera mounted at the front of the vehicle (e.g., a camera of a collision avoidance or active safety system carried on or in the front bumper), one or more cameras carried on the sides of the vehicle (e.g., park assist cameras carried on or in the side mirrors of the vehicle), or camera(s) arranged in other suitable ways. Accordingly, it will be appreciated that any number of cameras mounted in any number of places about the vehicle may be used, and therefore, the present disclosure is not intended to be limited to any particular number or location of the camera(s) 36.

Warning devices 16 may include any type of output device or other component that can be used to notify, alert, and/or otherwise warn the occupant(s) of the vehicle 10 about information relating to the road surface. Some examples of possible warning devices include visual warning devices, audible warning devices, haptic warning devices, and other miscellaneous warning devices, and each of these devices can receive control signals from one or more components of vehicle control system 12 for their activation. As their name suggests, visual warning devices use visual alerts (e.g., messages, the illumination of one or more indicator lights or symbols, etc.) to provide information relating to the road surface being traversed by the vehicle. Some possible visual warning devices 16 include a graphic display unit, a driver information center, an infotainment unit, vehicle instrumentation and controls, and a heads-up-display unit, to cite a few possibilities. Audible warning devices are similarly intended to provide information relating to the road surface being traversed by the vehicle, but to do so with the use of audible messages or sounds. For instance, an audible warning device could include a vehicle radio, an infotainment unit, a speaker located within the passenger cabin of the vehicle, as well as other components that emit sounds such as audible messages. Haptic warning devices rely on the sense of touch or feel to alert the vehicle occupant(s) and may include vibrations or other mechanical disturbances in the steering wheels, safety belt, or seats, for example. For example, if the road surface has a classification that corresponds to what may be considered to be a treacherous or dangerous condition, a haptic warning may be provided to make the occupant(s) (e.g., driver) aware of that condition. Other types of warning devices are certainly possible, as the present system and method are not limited to any particular ones.

Navigation system or unit 18 provides the system 12 with navigation readings that represent the location or position of the vehicle 10 and/or roads in the vicinity of the vehicle 10. As is known in the art, the navigation unit 18 may also provide the vehicle occupant(s) with alternate route information in an instance where the classification of the road surface being traversed warrants such information (e.g., when the road surface is classified as being impassable due to, for example, snow or ice). Depending on the particular implementation, navigation unit 18 may be a stand-alone vehicle control module or may be integrated within some other component or system within the vehicle (e.g., the telematics unit 20 described below). The navigation unit 18 may include any combination of components, devices, modules, etc., like a GPS unit or a memory device with stored map data, and may use the current position of the vehicle 10 and road- or map-data to evaluate upcoming road segments. It is also possible for navigation unit 18 to have some type of user interface so that information can be verbally, visually, or otherwise exchanged between the unit and occupant(s) of the vehicle. The navigation unit 18 can store pre-loaded map data and the like, or it can wirelessly receive such information through the telematics unit 20 or some other communications device of the vehicle, to cite a few possibilities. Any suitable navigation unit may be used, as the present system and method are not limited to any particular type.

Telematics unit 20 can be used to provide a diverse range of vehicle services, some of which involve wireless communication to and/or from the vehicle 10. An illustrative example of a telematics unit is that described in U.S. Patent Publication No. 2014/0067152 published on Mar. 6, 2014, the entire contents of which are incorporated herein by reference. To summarize, however, telematics unit 20 enables wireless voice and/or data communication over a wireless carrier system and via wireless networking. This enables the vehicle to communication with, for example, a call center, other telematics-enabled vehicles, or some other entity or device. Telematics unit 20 also enables vehicle 10 to offer a number of different services including those related to one or more of navigation, telephony, emergency assistance, diagnostics, infotainment, fleet management, etc. In an embodiment, the telematics unit 20 comprises a vehicle control module that includes a standard cellular chipset for voice communications like hands-free calling, a wireless modem for data transmission, an electronic processing device, one or more digital memory devices, and a dual antenna. The processing device of the telematics unit 20 can be any type of device capable of processing electronic instructions including microprocessors, microcontrollers, host processors, controllers, vehicle communication processors, and application specific integrated circuits (ASICs). It can be a dedicated processor used only for telematics unit 20, or it can be shared with other vehicle systems (e.g., infotainment system, navigation unit 18, etc.). The processor executes various types of digitally-stored instructions, such as software or firmware programs stored in a memory device that is accessible by the processor, which enable telematics unit 20 to provide a wide variety of services or perform a number of functions, including, in at least some embodiments, some of those functions of the method described below. These services or functions may include, for example: turn-by-turn directions and other navigation-related services provided in conjunction with the navigation unit 18; emergency or roadside assistance-related services; diagnostic reporting using one or more diagnostic modules; infotainment services; and providing notifications or alerts relating to the road surface being traversed by the vehicle 10 to a call center, one or more other vehicles, and/or another entity.

VSMs 22 of vehicle control system 12 may include any control modules or units within the vehicle 10 (or vehicle control modules) that can perform various functions or take various actions in response to the classification of the road surface being traversed by the vehicle and control signals received from, for example, control module 24, pattern classifier 26, or another component. VSMs 22 may include, for example and without limitation, an engine control module (ECM), a traction control system (TSC), electronic stability control (ESC) system, an antilock brake system (ABS), and/or a collision avoidance or active safety system, to cite a few possibilities. In an instance wherein the telematics unit 20 does not perform infotainment-related and/or diagnostic functions, VSMs 22 may also include an infotainment module for providing infotainment services, and/or one or more diagnostic modules for logging diagnostic-related information relating to the operation of the vehicle, and in some embodiments, performing one or more diagnostic-related functions. All of the VSMs 22 identified above are well known in the art, and as such, a detailed description of those VSMs will not be provided. Additionally, it will be appreciated that control system 12 or vehicle 10 may include VSMs other than those specifically identified above, and therefore, the present disclosure is not intended to be limited to any particular VSMs.

Control module 24 is coupled, either wirelessly or by a hardwired connection (e.g., via bus 28), to one or more of the sensor(s) 14 and/or one or more of the warning devices 16, navigation unit 18, telematics unit 20, VSMs 22, pattern classifier 26, or a combination thereof, so that it can gather sensor readings from the sensors and in at least certain embodiments, provide command signals to the warning devices, navigation unit, telematics unit, and/or VSM(s) according to the present method. Control module 24 is a vehicle control module that includes any variety of electronic processing devices, memory devices, input/output (I/O) devices, and/or other known components, and may perform various functions including, among potentially others, one or more of the functions of the present method. In an illustrative embodiment, control module 24 comprises some type of electronic control unit (ECU) or vehicle control unit (VCU), and includes an electronic memory device 38 that stores sensor readings (e.g., readings from sensor(s) 14), look-up tables or other data structures, algorithms, etc. used in the performance of method described below. As illustrated in FIG. 2, control module 24 also includes an electronic processing device 40 (e.g., a microprocessor, a microcontroller, an application specific integrated circuit (ASIC), etc.) that executes instructions for software, firmware, programs, algorithms, scripts, etc. that are stored in memory device 38 and may at least partially govern the processes and methods described herein. Depending on the particular implementation, the control module 24 may be a stand-alone vehicle control module, may be incorporated or included within another vehicle control module (e.g., a VSM 22, infotainment module, telematics unit 20, etc.), or may be part of a larger network or system of vehicle 10, to name a few possibilities. Accordingly, the control module 24 is not limited to any one particular embodiment or arrangement.

It will be appreciated that the aforementioned navigation unit 18, telematics unit 20, VSMs 22, and control module 24 may each comprise a vehicle control module that includes a combination of electronic processing devices, memory devices, input/output (I/O) devices, and other known components, and they may be electronically connected to other vehicle devices and modules via a suitable vehicle communications network (e.g., bus 28), and may interact with them when required. It should be appreciated that the basic architecture, structure, and overall arrangement of such modules are well known in the art and are, therefore, not described here in further detail.

The pattern classifier or classification system 26 is configured to use electrical signals received from one or more of the sensors 14 to classify the road surface being traversed by the vehicle. The pattern classifier 26 may classify a road surface in terms of one or more characteristics of the road surface being classified. For example, the road surface may be classified in terms of road surface type (e.g., asphalt, concrete, gravel, dirt, etc.), road surface condition (e.g., wet, snow-covered, ice-covered, potholed, etc.), or a combination of both characteristics. In an illustrative embodiment, the classifier 26 is configured to: identify a pattern in a detected vibration represented by electrical signal(s) received from one or more of sensors 14; match the identified pattern to one or more known patterns, wherein each known pattern corresponds to a respective road surface classification, and then classify the road surface in accordance with the road surface classification corresponding to the known pattern matching the identified pattern. Pattern classifier 26 may be one of any number of types known in the art, for example, a Hidden Markov Model (HMM), a neural network, a Bayesian-based, or a vector quantization type classifier, all of which are well known in the art, and therefore, will not be described here in further detail. The pattern classifier 26 may be implemented or synthesized in a number of ways including, but certainly not limited to, those ways described below.

In one embodiment, the pattern classifier 26 may be embodied in any vehicle control module having an electronic processing device configured to execute a pattern classification algorithm that may be stored in an electronic memory that is part of the vehicle control module or at least accessible by processing device thereof. For example, in the embodiment illustrated in FIGS. 1 and 2, the classifier 26 is integrated into the control module 24 of the control system 12. In such an embodiment, the classification algorithm may be stored in the electronic memory device 38 of the control module 24 and may be executed by the processing device 40 thereof. In other embodiments, however, the pattern classifier may be integrated in another component, for example, telematics unit 20, a VSM 22, etc., and the processing devices or units thereof may be configured to execute the classification algorithm. In another embodiment, the classifier 26 may comprise a standalone component comprised of a dedicated vehicle control module (e.g., the classifier 26 may be implemented or synthesized in hardware and/or on a dedicated chip (e.g., ASIC), digital signal processor, or another suitable vehicle control module). In one illustrative example, a finite state machine (FSM) is designed and a corresponding code is written in a hardware description language, for example, Verilog. Next, the FSM is synthesized into a vehicle control module as, for example, a field programmable gate array (FPGA) or a complex programmable logic device (CPLD). An analog-to-digital converter may also be used to quantize an analog signal received from a sensor 14 into a digital bit stream. While certain implementations of the classifier 26 have been specifically identified and described above, it will be appreciated that any suitable implementation may be used as the present system and method are not limited to any particular implementation of the classifier 26.

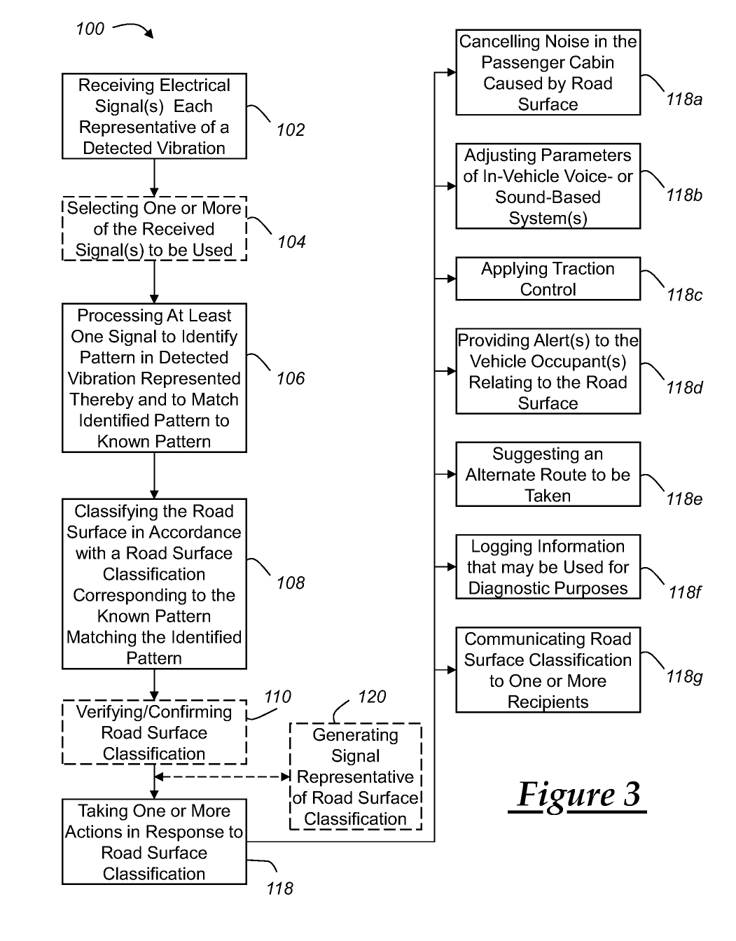

Turning to FIG. 3, there is shown an embodiment of a method 100 for classifying a road surface being traversed by a vehicle. For purposes of illustration and clarity, method 100 will be described in the context of vehicle 10 described above and illustrated in FIGS. 1 and 2, and vehicle control system 12 thereof, in particular. It will be appreciated, however, that the application of the present methodology is not meant to be limited solely to such a vehicle or arrangement, but rather method 100 may find application with any number of vehicles or arrangements (e.g., arrangements wherein component(s) of vehicle 10 other than the vehicle control system 12 is/are configured to perform some or all of the steps of method 100, etc.). Additionally, it will be appreciated that unless otherwise noted, the performance of method 100 is not meant to be limited to any one particular order or sequence of steps, or to any particular component(s) for performing the steps.

Method 100 comprises a step 102 of receiving one or more electrical signals each of which is representative of a vibration (e.g., a vibration in the form of a sound or a vibration of a vehicle component) detected by a sensor 14 carried by the vehicle. The output signals from the sensor(s) 14 may be sampled in accordance with any suitable sampling rate. Examples of possible sampling rates include, but are certainly not limited to, 16 kHz, 24 kHz, and 48 kHz, to cite a few possibilities. In an embodiment, the signal(s) are received by the pattern classifier or classification system 26 of the control system 12. Accordingly, in an embodiment wherein the classifier 26 is integrated into the control module 24 of the control system 12, step 102 comprises receiving the electrical signal(s) at one or more inputs of the control module 24. Alternatively, the signal(s) may be received by another vehicle control module of the control system or vehicle 10.

As described elsewhere above, the received signal(s) may comprise one or more types of signals. For example, one or more of the received signal(s) may comprise an audio signal representative of a sound detected by a microphone 30 carried by the vehicle 10, wherein the sound may comprise a sound generated by the interaction of the vehicle tires with the road surface as the tires travel over the road surface, or a sound generated as a result of the vibration of a structural component of the vehicle 10 caused by the vehicle traversing the road surface. One or more of the received signal(s) may alternatively comprise a vibration signal representative of a vibration detected by a vibration sensor 34 carried by the vehicle, wherein the detected vibration is a vibration of a component of the vehicle caused by the vehicle traversing the road surface. In at least some embodiments, one or more of the received signals may comprise signal(s) representative of a detected sound, while one or more other of the received signals may comprise signal(s) representative of a detected vibration of a component of the vehicle. Accordingly, in one embodiment, the received signals may comprise only one type of signal (e.g., audio/sound or component vibration), while in other embodiments, the received signals may comprise both types (e.g., audio/sound and component vibration).

In at least some embodiments wherein multiple signals are received in step 102, method 100 may include an optional step 104 of selecting which of the received signals to use or process in the subsequent steps of method 100 described below. For example, in an embodiment wherein the vehicle control system 12 includes a plurality of microphones 30 from which electrical signals are received in step 102, step 104 may comprise selecting the electrical signal(s) received from one or more, but less than all, of the microphone(s) 30 to be used in the manner described below. For example, step 104 may comprise selecting the electrical signals received from the two microphones 30 that formulate an optimal orientation at run time. This selection may be made using any number of techniques known in the art. In one embodiment, however, an adaptive beamforming technique may be used. Adaptive beamforming provides a way of seeking directivity and maximal audio susceptibility using a multitude of microphones. Blind beamforming may be used to help device whether to use all or a subset of the microphones 30 in a given cluster. It will be appreciated, however, that other techniques may be additionally or alternatively used as the present disclosure is not limited to any particular technique(s), or the microphones 30 may be used to acquire signals without any processing.

In an embodiment wherein the vehicle control system 12 includes a plurality of sensor clusters (e.g., microphone clusters 32a, 32b), step 104 may additionally or alternatively include selecting the electrical signals(s) received from only one of the clusters to be used as described below. More particularly, while in some instances output signals from each cluster may be used, in certain scenarios, various conditions (e.g., wind) may cause the outputs signals of the microphones 30 of one cluster to be significantly distorted. As such, the output signals from the microphones of that cluster may be effectively unusable for the purposes described herein. To account for this, the output signal(s) of the microphone(s) of each cluster may be evaluated to determine which signal(s), and therefore, which cluster, has the least distortion, and then one or more output signals received from that cluster may be used as described below. This evaluation may be performed in a number of ways. One way, though certainly not the only way, is by: determining or computing the signal-to-noise ratio for one or more signals received from each cluster using known techniques; comparing the ratio(s) of the signal(s) received from one cluster with the ratio(s) of the signal(s) received from one or more other clusters; and then determining which cluster has the least distorted output signals based on which signal(s) have the highest ratio (e.g., if a signal received from a microphone of cluster 32a has a higher ratio than a signal received from a microphone of cluster 32b, then output signals received from cluster 32a in step 102 may be selected for use. Once electrical signals received from a particular cluster have been selected, step 104 may further include selecting one or more, but less than all, of those signals to be used as described above.

In an embodiment, step 104 is performed by the component or device of vehicle control system 12 that receives the electrical signals in step 102. Accordingly, in some embodiments, step 104 may be performed by the pattern classifier 26 of system 12; though in other embodiments step 104 may be performed by a different component of system 12 or vehicle 10 (e.g., control module 24 in an instance wherein the classifier 26 is not integrated in the control module 24, another vehicle control module, etc.) as the present disclosure is not intended to be limited to any particular component(s) performing step 104.

Once one or more signal(s) have been received in step 102 and, if applicable, certain of the received signals have been selected in step 104 to be used as described below, method 100 includes a step 106 of processing each of one or more of the received signals to identify pattern in the detected vibration represented by the signal being processed, and then matching the identified pattern to one of one or more known patterns, wherein each known pattern corresponds to a respective road surface classification (e.g., a classification relating or corresponding to one or more characteristics of the road surface, for example, road surface type and/or condition). Step 106 may be performed for each signal received in step 102, or alternatively, for one or more but less than all of the received signals; and step 106 may be performed whether the signal(s) being processed are audio signal(s) representative of a detected sound, vibration signal(s) representative of a detected vibration of a component of the vehicle, or a combination of both. In an embodiment, step 106 is performed by the pattern classifier 26 of vehicle control system 12, which, as described above, may comprise any number of pattern classifiers or classification systems known in the art. Accordingly, in an embodiment, for each signal processed in step 106, the pattern classifier 26 is configured to identify a pattern in the detected vibration represented by that signal, and to then match that pattern to one of one or more known, empirically-derived patterns stored in a memory device (e.g., the memory device 38 of control module 24, in an embodiment wherein the classifier 26 is integrated in the control module 24).

Step 106 may be performed using any number of techniques known in the art. For example, in an illustrative embodiment, the signal being processed is first transformed into a feature vector using known feature extraction and/or feature selection techniques. Features that may be used for the purposes of this disclosure may include, for example and without limitation, Mel Cepstrum Coefficients and Bark Scale, to cite a few possibilities, that follow a non-linear frequency scale. As it relates to a vibration signal, the features may represent signal strength within each of a plurality of digital time frames (e.g., 10 ms, 20 ms). As it relates to audio signals or sound, the features may represent signal-to-noise ratio for each time frame, differential signal-to-noise ratio between consecutive frames, etc. In some embodiments, prior to transforming the signal into a feature vector, the signal may first be converted from an analog signal to a digital signal by, for example, the pattern classifier 26 or an analog-to-digital converter that is separate and distinct from the pattern classifier 26. Accordingly, in such an embodiment, method 100 may include converting the signal into a digital signal and then transforming the converted digital signal into a feature vector. In any event, the resulting feature vector may be compared with one or more known, empirically-derived models or patterns, each of which corresponds to a respective road surface classification (e.g., road surface type and/or road surface condition), and then matched to the pattern or model having the highest probability of matching the feature vector. It will be appreciated, that while a summary of one particular way in which step 106 may be performed has been provided, other techniques may additionally or alternatively be used as the present disclosure is not intended to be limited to any particular way of identifying a pattern and/or matching that pattern to a known pattern.

Once each signal to be processed in step 106 has been processed as described above, method 100 may proceed to a step 108 of classifying the road surface being traversed in accordance with the road surface classification(s) corresponding to the known pattern(s) to which the pattern(s) identified in step 106 was/were matched in step 106. For instance, if, in one example, a pattern in a detected vibration represented by a signal (e.g., a signal representative of a vibration of a vehicle component detected by a vibration sensor) is identified in step 106 and matched to a known pattern corresponding to a road surface classification of “asphalt,” the road surface would be classified in step 108 as being an “asphalt road surface.” Similarly, if, in another example, a pattern in a detected vibration represented by a signal (e.g., an audio signal representative of a sound generated as the vehicle travels over the road surface and that is detected by a microphone) is identified in step 106 and matched to a known pattern corresponding to a road surface classification of “wet road surface,” the road surface would be classified in step 108 as being a “wet road surface.” If, in yet another example, a pattern in a detected vibration represented by a first signal (e.g., a signal representative of a vibration of a vehicle component detected by a vibration sensor) is identified in step 106 and matched to a known pattern corresponding to a road surface classification of “asphalt,” and a pattern in a detected vibration represented by a second signal (e.g., an audio signal representative of a sound generated as the vehicle travels over the road surface and that is detected by a microphone) is identified in step 106 and matched to a known pattern corresponding to a road surface classification of “wet road surface,” the road surface would be classified in step 108 as being “wet asphalt.” It will be appreciated that the road surface classifications of “asphalt” and “wet road surface” are provided for illustrative purposes only, and as such, are only two possibilities of road surface classifications that may be determined by method 100. Accordingly, the present disclosure is not intended to be limited to any particular road surface classification(s) or characteristic(s) in terms of which the road surface may be classified.

In an embodiment, step 108 may be performed by the pattern classifier 26, or alternatively, by another component of vehicle control system 12 or vehicle 10 (e.g., another vehicle control module) that is coupled to and configured to communicate with classifier 26. In one embodiment wherein the pattern classifier 26 is integrated in the control module 24, step 108 is performed by the processing device 40 of control module 24. It will be appreciated, however, that in other embodiments step 108 may be performed by another suitable component of the control system 12 or vehicle 10 as the present disclosure is not limited to any particular component(s) for performing step 108.

Upon the classification of the road surface in step 108, method 100 may include one or more additional steps, some or all of which may be optional. For example, in an illustrative embodiment, method 100 may include a step 110 of confirming or verifying the accuracy of the classification made in step 108. This may be accomplished in a number of ways. In one example, one or more signals received in step 102 that were not used in the initial classification of the road surface in steps 104-108 may be used (i.e., signals that were not selected in step 104 and/or processed in step 106, may be used to verify the classification made in step 108). Accordingly, one or more signals that are representative of a vibration detected by a sensor 14 (e.g., a microphone 30 or a vibration sensor 34) may be used to verify the road surface classification. In such an embodiment, some or all of steps 104-108 may be repeated or performed for each signal being used to verify or confirm the initial road surface classification determined in step 108, and one or more road surface classifications may be determined. The road surface classification(s) determined as part of step 110 may then be compared with the initial classification(s) determined in step 108. If the classifications match each other, then a determination can be made in step 110 that the initial classification made in step 108 is accurate. Conversely, if the classifications do match, it can be determined in step 110 that the initial classification made in step 108 is inaccurate, and method 100 may loop back to step 102 and be repeated, or may terminate altogether.

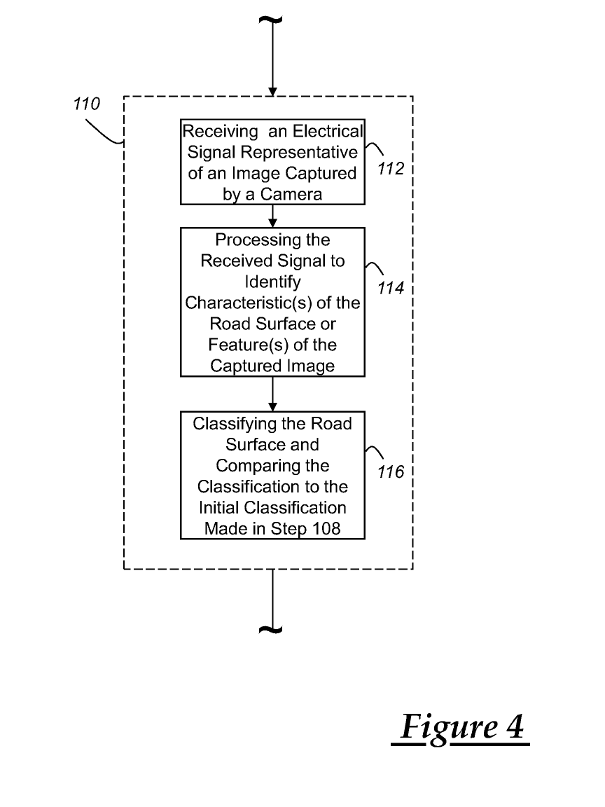

In another example, rather than using electrical signal(s) received 102 that is/are representative of a detected vibration, step 110 may include receiving one or more additional electrical signals from sensor(s) 14 that is/are not configured to detect vibration (i.e., that are not microphones or vibration sensors), and then using that or those signals to verify or confirm the initial road surface classification made in step 108. For example, in the illustrative embodiment shown in FIG. 4, step 110 includes a substep 112 of receiving an electric signal from a camera carried by the vehicle 10, with the signal being representative of an image of the road surface captured by the camera. Following the receipt of this signal in substep 112, verifying step 110 may include a substep 114 of processing the signal using known image processing techniques to identify one or more characteristics of the road surface, or one or more features of the captured image, that may then be used to classify the road surface. This may comprise, for example, using well known image recognition techniques to match the captured image, or one or more features thereof, to one of one or more known, empirically-derived images stored in or on a memory device, wherein each known image corresponds to a respective road surface classification (e.g., road surface type and/or condition). Following substep 114, step 100 may comprise a step substep 116 of classifying the road surface being traversed in accordance with or based on the road surface classification(s) corresponding to the known image to which the captured image was matched in substep 114. For instance, if, in one example, the captured image was matched to a known image corresponding to a road surface classification of “asphalt,” the road surface would be classified in substep 116 as being an “asphalt road surface.” Similarly, if, in another example, the captured image was matched to a known image corresponding to a road surface classification of “snow covered road surface,” the road surface would be classified in substep 116 as being a “snow covered road surface.” And so on and so forth. It will be appreciated that the road surface classifications described above are provided for illustrative purposes only, and as such are, only two possibilities of road surface classifications that may be determined. Accordingly, the present disclosure is not intended to be limited to any particular road surface classification(s). In any event, step 116 may further include comparing the classification made using the signal received from the camera with the initial classification(s) determined in step 108. If the classifications match each other, then a determination can be made that the initial classification is accurate. Conversely, if the classifications do match, it can be determined that the initial classification is inaccurate, and method 100 may loop back to step 102 and be repeated, or may terminate altogether.

Depending on the particular implementation of method, step 110 may be performed by any number of components of vehicle control system 12 or vehicle 10. For example, in an embodiment wherein signals(s) received in step 102 are used in step 110, step 110 may be performed by the pattern classifier 26. In other embodiments, however, another component of vehicle control system 12 or vehicle 10 may be used. In one example, step 110 is performed by the processing device 40 of control module 24 within which, in at least some embodiments, the pattern classifier 26 is integrated. It will be appreciated, however, that in other embodiments, step 110 may be performed by a suitable component of the control system 12 or vehicle 10 other than the control module 24 as the present disclosure is not limited to any particular component(s) for performing step 110.

Whether or not method 100 includes step 110, in an embodiment method 100 includes a step 118 of taking, or commanding the taking of, one or more actions in response to the classification made in step 108, including, but not limited to, one or more of those described below. In an embodiment wherein the pattern classifier 26 is not a standalone device or module, but rather is integrated into a component of the vehicle 10, for example, the control module 24, that component may be configured to take certain actions or to command or effectuate the taking of certain actions in step 118 in response to the road surface classification. In an embodiment wherein the pattern classifier 26 is a standalone device or is integrated into a component of vehicle control system 12 or vehicle 10 that is not configured to take or effectuate certain actions in response to the road surface classification, method 100 may include an intermediate step 120 of generating an output signal representative of the road surface classification and communicating that signal to one or more components of control system 12 or vehicle 10 that is/are configured to take or effectuate the taking of certain prescribed action(s). This signal may take any number of forms. For example, a digital signal may be generated that is indicative of the classification determined in step 108. Depending on the particular number of ways that a road surface may be classified in a given implementation (e.g., classified in terms of road surface type, road surface condition, or both, the number of different road surface types and/or conditions, etc.) the digital signal may comprise a single bit signal (i.e., a “0” for one classification (e.g., asphalt) and a “1” for a different classification (e.g., concrete)), or a multi-bit signal that may be used to classify the road surface in terms of road surface type, road surface condition, or both (e.g., “00” for asphalt, “01” for wet asphalt, “10” for concrete, and “11” for wet concrete).

In any event, any number of actions may be taken or commanded in step 118 in response to the road surface classification made or determined in step 108, and, if applicable, the verification/confirmation in step 110 of the initial classification made in step 108. What action(s), if any, are taken may be directly dependent on the classification of the road surface. In other words, each possible road surface classification may have one or more predetermined or prescribed action(s) associated therewith that is/are taken when it is determined in step 108 that the road surface has that particular classification.

One such action that may be taken or commanded in step 118 (i.e., step 118a) relates to the spatial cancellation of noise in the passenger cabin of the vehicle 10 caused by the vehicle traversing the road surface (e.g., when traversing a concrete road surface, a continuous noise is generated in the passenger cabin with intermittent “thumps” as the vehicle passes over transitions between concrete slabs). In such an embodiment, step 118a may include a substep (not shown) of determining, based on the classification made in step 108, information relating to noise generated in the passenger cabin of the vehicle caused by the vehicle traversing a road surface having that particular classification. For example, a noise profile for each type of road surface classification may be empirically-derived and stored in a look-up table or other data structure stored in or on a memory device of the vehicle control system 12 (e.g., memory device 38 of control module 24) or another component of the vehicle 10 (e.g., a memory device of a component of vehicle 10 that received a signal representative of the road surface classification and that is configured to perform a noise cancellation function (e.g., an infotainment module of vehicle 10)). The look-up table or data structure may be used to correlate the classification determined in step 108 with a corresponding noise profile, and based on that noise profile, appropriate noise cancellation may be applied to spatially cancel, or at least mitigate, the noise in the passenger cabin caused by the vehicle traversing the road surface. This noise cancellation may be performed using active noise control (ANC) techniques that are well known in the art and for which a detailed description will not be provided. In an embodiment, the same component that is configured to classify the road surface may be configured to perform the noise cancellation functionality of step 118 (e.g., the control module 24); while in other embodiments, a different component may be used (e.g., one of VSMs 22). In the latter instance, the classification made in step 108 may be communicated to the component configured to perform the noise cancellation function (e.g., via the signal generated in step 120 described above) and then used to perform the noise cancellation functionality. Accordingly, it will be appreciated that the present disclosure is not limited to the noise cancellation functionality being performed by any particular component(s) of vehicle control system 12 or vehicle 10, but rather any suitable component may be used.

Another action that may be taken or commanded in step 118 (i.e., step 118b) relates to the adjusting or setting of operating parameters of certain in-vehicle voice- or speech-based systems or features (e.g., speech-recognition or voice-activated systems and features (e.g., hands-free calling)) to account for noise in the passenger cabin caused by the vehicle traversing the road surface. In such an embodiment, and similar to the noise cancellation functionality described above, step 118b may include a substep (not shown) of determining, based on the classification made in step 108, information relating to noise generated in the passenger cabin of the vehicle caused by the vehicle traversing a road surface having that particular classification. For example, a noise profile for each type of road surface classification may be empirically-derived and stored in a look-up table or other data structure stored in or on a memory device of the vehicle control system 12 (e.g., memory device 38 of control module 24) or another component of the vehicle 10 (e.g., a memory device of a component of vehicle 10 that received a signal representative of the road surface classification and that is configured to perform step 118b). The look-up table or data structure may be used to correlate the classification determined in step 108 with a corresponding noise profile, and based on that noise profile, one or more operating parameters of one or more voice- or speech-based features or systems may be adjusted or set to account for the noise in the passenger cabin caused by the vehicle traversing the road surface. In an embodiment, the same component that is configured to classify the road surface may be configured to perform the functionality of step 118b (e.g., the control module 24); while in other embodiments a different component may be used (e.g., one of VSMs 22). In the latter instance, the classification made in step 108 may be communicated to the component configured to perform the functionality of step 118b (e.g., via the signal generated in step 120 described above) and then used as described above. Accordingly, it will be appreciated that the present disclosure is not limited to step 118b being performed by any particular component(s) of vehicle control system 12 or vehicle 10, but rather any suitable component may be used.

Yet another action that may be taken or commanded in step 118 (i.e., step 118c) relates to traction control of the vehicle. More particularly, upon determining a classification of the road surface in step 108, the classification may be used by a traction control system (TCS) of the vehicle, which may be a standalone system or may be integrated into another component of control system 12 or vehicle 10 (e.g., control module 24, a VSM 22 (e.g., a brake module or ABS), etc.), to determine whether traction control is needed to help prevent loss of traction of the driven wheels of the vehicle, and if so, to apply appropriate traction control. In an embodiment, a traction control profile for each type of road surface classification may be empirically-derived and stored in a look-up table or other data structure stored in or on a memory device of or accessible by the TCS. The look-up table or data structure may be used to correlate the classification determined in step 108 with a corresponding traction control profile, and based on that profile, the TSC may adjust or command the adjustment of one or more operating parameters of the vehicle 10, for example, one or a combination of an adjustment to the brake force being applied to one or more wheels of the vehicle, a reduction of fuel to one or more cylinders of the vehicle, a reduction in engine power, etc. In an embodiment, the same component that is configured to classify the road surface may act as the TCS and/or be configured to perform the traction control functionality in step 118c (e.g., the control module 24); while in other embodiments, a different component of vehicle 10 or a standalone TCS may be used. In the latter instance, the classification made in step 108 may be communicated to the component configured to perform the functionality of step 118c (e.g., via the signal generated in step 120 described above) and then used as described above. Accordingly, it will be appreciated that the present disclosure is not limited to step 118c being performed by any particular component(s) of vehicle control system 12 or vehicle 10, but rather any suitable component may be used.

Yet still another action that may be taken or commanded in step 118 (i.e., step 118d) relates to alerting the occupant(s) of the vehicle of the road surface classification. More particularly, upon determining a classification of the road surface in step 108, one or more alerts or notifications relating to the road surface may be provided to the vehicle occupant(s). In an embodiment, the alert(s) or notification(s) may be communicated to the vehicle occupant(s) via the warning device(s) 16 of vehicle control system 12, and may take any number of forms depending on the type(s) of warning device(s) 16 that are provided. In an embodiment, the alert(s) provided is/are classification dependent. For example, for each type of road surface classification, an alert profile containing one or more (or no) alerts or notifications may be created and stored in a look-up table or other data structure stored in or on a memory device of the vehicle control system 12 (e.g., memory device 38 of control module 24, or a memory device of another component configured to control the provision of in-vehicle alerts (e.g., an infotainment unit, telematics unit 20, etc.)). The look-up table or data structure may be used to correlate the road surface classification with a corresponding alert profile, and based on that profile, one or more alerts may be provided to the vehicle occupant(s) via the warning device(s) 16. As described elsewhere above, the alerts provided may include audible, visual, and/or haptic alerts, and they may identify certain characteristics of the road surface (e.g., the type or one or more conditions) and/or comprise warnings relating to the nature of the road surface (e.g., warnings that the surface is impassable, treacherous, clear, etc.) In an embodiment, the same component that is configured to classify the road surface may determine which alert(s), if any, should be provided and then control the necessary warning device(s) 16 to provide such alerts (e.g., the control module 24); while in other embodiments a different component of vehicle control system 12 may be used (e.g., an infotainment module, the telematics unit 20, etc.). In the latter instance, the classification made in step 108 may be communicated to the component configured to provide or generate the alerts (e.g., via the signal generated in step 120 described above) and then used as described above. Accordingly, it will be appreciated that the present disclosure is not limited to step 118d being performed by any particular component(s) of vehicle control system 12 or vehicle 10, but rather any suitable component may be used.

A further action that may be taken or commanded in step 118 (i.e., step 118e) comprises determining an alternative route for the vehicle to take based on the road surface classification. More particularly, if the road surface classification determined in step 108 is one that may be considered to be particularly treacherous or difficult to traverse (e.g., is icy, snow covered, etc.), an alternative route may be determined and provided or suggested to the driver in an attempt to find a more desirable and/or safe road surface to traverse. Accordingly, in an embodiment, at least certain road surface classifications may be identified as classifications for which alternate routes should be determined. When a particular road surface being traversed is classified as one of those classifications, an alternate route may be determined. Step 118e may be performed by any suitable component of vehicle control system 12 or vehicle 10, for example, navigation system 18 or telematics unit 20, to cite a few possibilities. In an embodiment wherein the component configured to perform step 118e is different than the component that classifies the road surface in step 108, the classification made in step 108 may be communicated to that component (e.g., via the signal generated in step 120 described above) and then used to determine an alternate route, if necessary.

In addition to or instead of the actions described above, in an embodiment, step 118 (i.e., step 118f) may comprise logging information that may be used for diagnostic purposes. More particularly, information such as road surface classification and the amount of time that the vehicle traversed road surfaces having that or those classifications may be determined and stored or logged in, for example, a memory device of vehicle control system 12 or vehicle 10 (e.g., the memory device 38 of control module 24, a memory device of a diagnostics module, etc.). Accordingly, the road surface classification determined in step 108 and the amount of time the vehicle traversed that road surface, which may be determined using a known timer, may be logged for diagnostic purposes. Information logged over time may then be used for various diagnostic purposes, such as, for example, to determine the wear on the treads of the vehicle tires and/or to estimate whether the tire tread is above or below a certain predetermined level (e.g., a safety level), to cite a few possibilities. In certain instances, an alert or notification may be provided to the occupant(s) of the vehicle based on the diagnostics performed in response to the logged information. For example, if a tire tread is estimated to be below a particular threshold, an alert may be provided to the occupant(s) via one or more of the warning devices 16. Step 118f may be performed by any suitable component of vehicle control system 12 or vehicle 10, for example, control module 24, a suitably configured VSM 22, telematics unit 20, or a diagnostics module, to cite a few possibilities. In an embodiment wherein the component configured to perform step 118f is different than the component that classifies the road surface in step 108, the classification made in step 108 may be communicated to that component (e.g., via the signal generated in step 120 described above) and then logged and used as described above.

Another action that may be taken or commanded in step 118 (i.e., step 118g) comprises communicating or broadcasting the road surface classification, or a warning or alert corresponding thereto, to one or more recipients over a communications network. More particularly, if the vehicle 10 is part of a vehicle fleet or is configured to communicate with other vehicles in the same vicinity of vehicle 10, an electrical signal may be generated that is representative of both the classification determined in step 108 and the location of vehicle 10. In an embodiment, step 118g may be performed for any road surface classification determined in step 108; while in other embodiments, step 118g may be performed only for certain predetermined classifications (e.g., those corresponding to adverse road conditions). Step 118g may be performed by any suitable component or combination of components of vehicle control system 12 or vehicle 10. For example, in one embodiment, vehicle telematics unit 20 may obtain the road surface classification from, for example, the pattern classifier 26, and the vehicle location from navigation unit 18. The telematics unit 20 may then generate one or more electrical signals representative of the road surface classification and the vehicle location, and then communicate that or those signal(s) to one or more recipients over a suitable communications network, such as, for example, that described in US Patent Publication No. 2014/0067152, the entire contents of which were incorporated by reference above. The recipients of the signal(s) may include, for example, certain vehicles equipped with telematics units that are coupled to the communication network to which the telematics unit 20 of vehicle 10 is coupled, a call center or dispatch center to which the telematics unit 20 is configured to communicate with, or other vehicles or entities with which telematics unit 20 is able to communicate. In any event, in embodiment wherein the component configured to perform step 118g is different than the component that classifies the road surface in step 108 and/or the component that is configured to determine a location of the vehicle, the classification made in step 108 and/or the vehicle location may be communicated to that component and then used to as described above.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for classifying a road surface being traversed by a vehicle, comprising:
receiving, at a pattern classification system, one or more electrical signals each representative of a vibration detected by a sensor carried by the vehicle;
for at least one of the received electrical signals, identifying, by the pattern classification system, a pattern in the detected vibration represented thereby, and matching, by the pattern classification system, the identified pattern to one of one or more known patterns, wherein each known pattern corresponds to a respective road surface classification; and
classifying, by the pattern classification system, the road surface in accordance with the road surface classification corresponding to the known pattern matching the identified pattern.

2. The method of claim 1, wherein at least one of the one or more received electrical signals comprises an audio signal, and the detected vibration represented thereby comprises sound detected by a microphone carried by the vehicle.

3. The method of claim 2, wherein the sound is a sound generated as one or more tires of the vehicle traverse the road surface.

4. The method of claim 2, wherein the sound is a sound generated by a vibration of a component of the vehicle.

5. The method of claim 1, wherein at least one of the one or more received electrical signals comprises a vibration signal, and the detected vibration represented thereby comprises a vibration of a component of the vehicle detected by a vibration sensor carried by the vehicle.

6. The method of claim 1, wherein identifying the pattern in the detected vibration comprises transforming the at least one of the received electrical signals into a feature vector, and the matching of the identified pattern comprises matching the feature vector to a known pattern stored in a memory device of the vehicle control module.

7. The method of claim 1, wherein each road surface classification is in terms of a road surface type, a road surface condition, or both.

8. The method of claim 1, wherein in response to the classification of the road surface, the method further comprises:
determining, based on the road surface classification, information relating to noise in a passenger cabin of the vehicle caused by the vehicle traversing the road surface; and
applying noise cancellation and/or adjusting one or more operating parameters of one or more in-vehicle voice-based systems to account for noise in the passenger cabin of the vehicle caused by the road surface.

9. The method of claim 1, wherein in response to the classification of the road surface, the method further comprises generating an output signal to at least one of:
apply traction control to account for the road surface;
provide an alert to occupant(s) of the vehicle relating to the road surface;
determine an alternate route for the vehicle to take; or
electronically communicate the classification of the road surface to one or more recipients over a communications network.

10. The method of claim 1, wherein the receiving step comprises receiving a plurality of electrical signals, and the method further comprises selecting the at least one of the received electrical signals from the plurality of electrical signals based on the signal-to-noise ratio of two or more of the plurality of received electrical signals.

11. The method of claim 1, wherein the receiving step comprises receiving a plurality of electrical signals, and the method further comprises selecting the at least one of the received electrical signals from the plurality of electrical signals using an adaptive beamforming technique.

12. A method for classifying a road surface being traversed by a vehicle, comprising:
receiving, at a pattern classification system, at least one audio signal representative of a sound detected by a microphone carried by the vehicle, and at least one vibration signal representative of a vibration detected by a vibration sensor carried by the vehicle;
for each of the at least one audio signal and at least one vibration signal, identifying, at the pattern classification system, a pattern in the detected sound and detected vibration, respectively, and matching, at the pattern classification system, the identified pattern in the detected sound to a first of a plurality of known patterns, and the identified pattern in the detected vibration to a second of the plurality of known patterns, wherein the first known pattern corresponds to a road surface classification that is in terms of a first characteristic of the road surface, and the second known pattern corresponds to a road surface classification that is in terms of a second characteristic of the road surface; and
classifying, at the vehicle control module, the road surface in accordance with the road surface classifications corresponding to the first and second known patterns.

13. The method of claim 12, wherein the detected sound is a sound generated as one or more tires of the vehicle traverse the road surface, and the detected vibration is a vibration of a component of the vehicle.

14. The method of claim 12, further comprising transforming the at least one audio signal and at least one vibration signal into respective feature vectors, and then using the feature vectors to both identify the patterns in the corresponding audio and vibration signals, and match the identified patterns to the respective first and second known patterns.

15. The method of claim 12, wherein the road surface classification corresponding to the first known pattern comprises a classification in terms of a road surface condition, and the road surface classification corresponding to the second known pattern comprises a classification in terms of a road surface type.

16. The method of claim 12, wherein in response to the classification of the road surface, the method further comprises:
determining, based on the road surface classification, information relating to noise in a passenger cabin of the vehicle caused by the vehicle traversing the road surface; and
applying noise cancellation and/or adjusting one or more operating parameters of one or more in-vehicle voice-based systems to account for noise in the passenger cabin of the vehicle caused by the road surface.

17. The method of claim 12, wherein in response to the classification of the road surface, the method further comprises generating an output signal to at least one of:
apply traction control to account for the road surface;
provide an alert to occupants) of the vehicle relating to the road surface;
determine an alternate route for the vehicle to take; or
electronically communicate the classification of the road surface to one or more recipients over a communications network.

18. A vehicle control system for classifying a road surface being traversed by a vehicle, comprising:
one or more sensors carried by the vehicle and each being configured to detect a vibration;
a pattern classification system electrically connected to the one or more sensors and configured to receive one or more electrical signals representative of a detected vibration from the one or more sensors, wherein the pattern classification system is configured to:
identify a pattern in the detected vibration represented by at least one of the one or more received electrical signals;
match the identified pattern to one of one or more known patterns, wherein each known pattern corresponds to a respective road surface classification; and
classify the road surface in accordance with the road surface classification corresponding to the known pattern matching the identified pattern.

19. The vehicle control system of claim 18, wherein the one or more sensors comprises one or more microphones, and further wherein the one or more microphones is configured to detect a vibration in the form of a sound generated as one or more tires of the vehicle traverses the road surface, or a sound generated by a vibration of a component of the vehicle.

20. The vehicle control system of claim 18, wherein the one or more sensors comprises at least one vibration sensor configured to detect a vibration in the form of a vibration of a component of the vehicle.
